(19) United States
(12) Patent Application Publication
(10) Pub. No.: US 2008/0005376 A1
(43) Pub. Date: Jan. 3, 2008

(54) APPARATUS FOR A NON-INTRUSIVE IEEE1394B-2002 BUS INTERFACE INCLUDING DATA MONITORING FUNCTIONS OF CRITICAL PHYSICAL LAYER STAGES

(75) Inventors: Cor Jansen, Nijmegen (NL); Carlo Bogaerts, Westmalle (BE); Casper van Doorne, Nijmegen (NL); Michael Erich Vonbank, Phoenix, AZ (US)

Correspondence Address: Michael Vonbank, 3640 E. Desert Willow Rd., Phoenix, AZ, 85044, US

(73) Assignee: DAPHOLDING B.V., Nijmegen (NL)

(21) Appl. No.: 11/383,488

(22) Filed: May 15, 2006

(51) Int. Cl. G06F 3/00

(52) U.S. Cl. 710/15

(57) ABSTRACT

In a fully non-intrusive bus monitoring interface the bus under test is not affected at all by the presence of the bus monitor. Other bus devices do not recognize the monitor as it does not participate in the bus arbitration and tree identification. The bus monitor is completely invisible to the bus / devices under test as it is not assigned its own nodeID, does not transmit a SelfID packet and is not affecting the bus topology. Furthermore, the device does not add any delays into the signal propagation between two devices and has neglectable influence on signal quality. However, it still provides the necessary means to tap into the signal transmissions to detect bus symbols and convert them into suitable data patterns for subsequent data analysis.

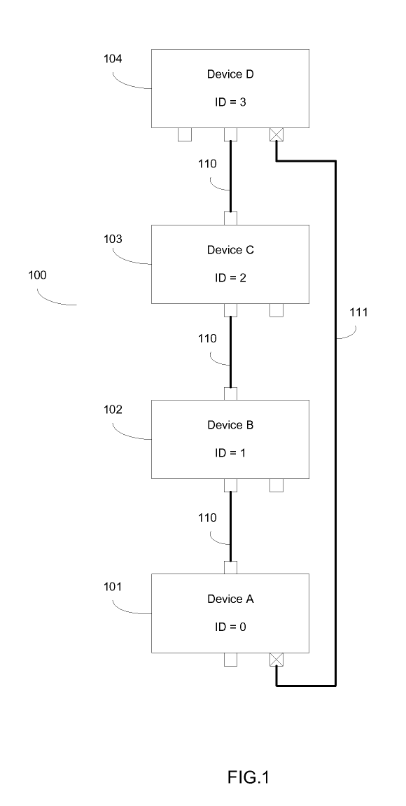

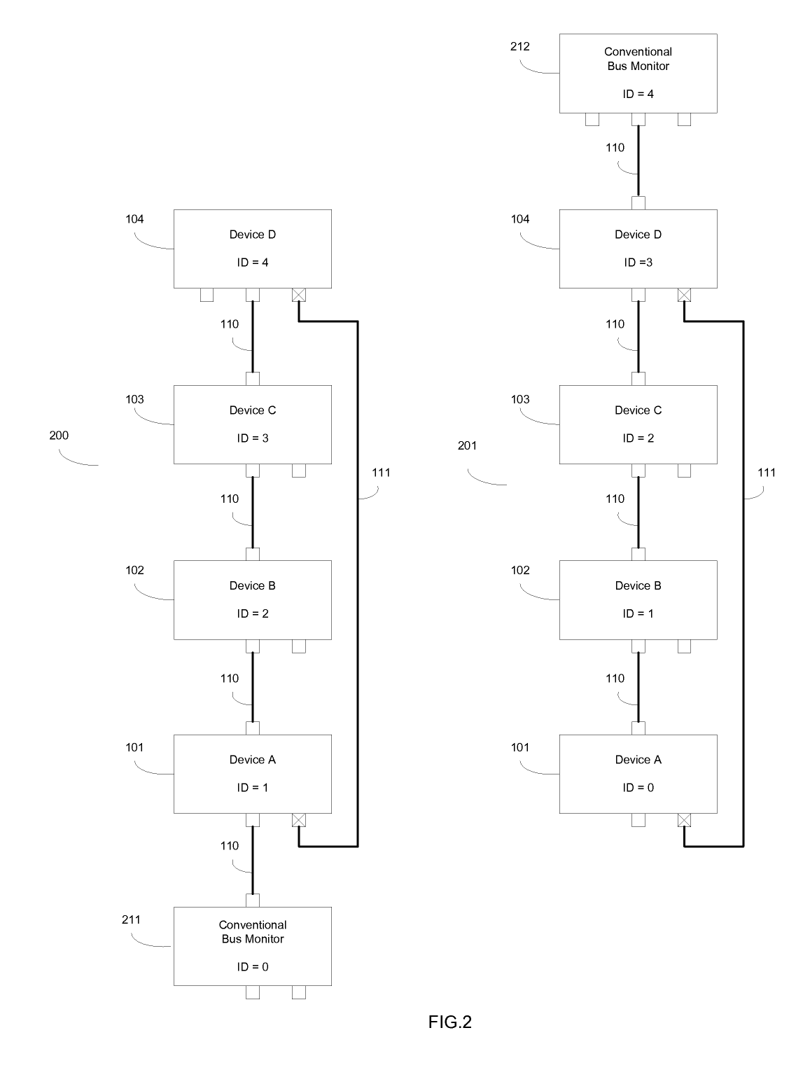

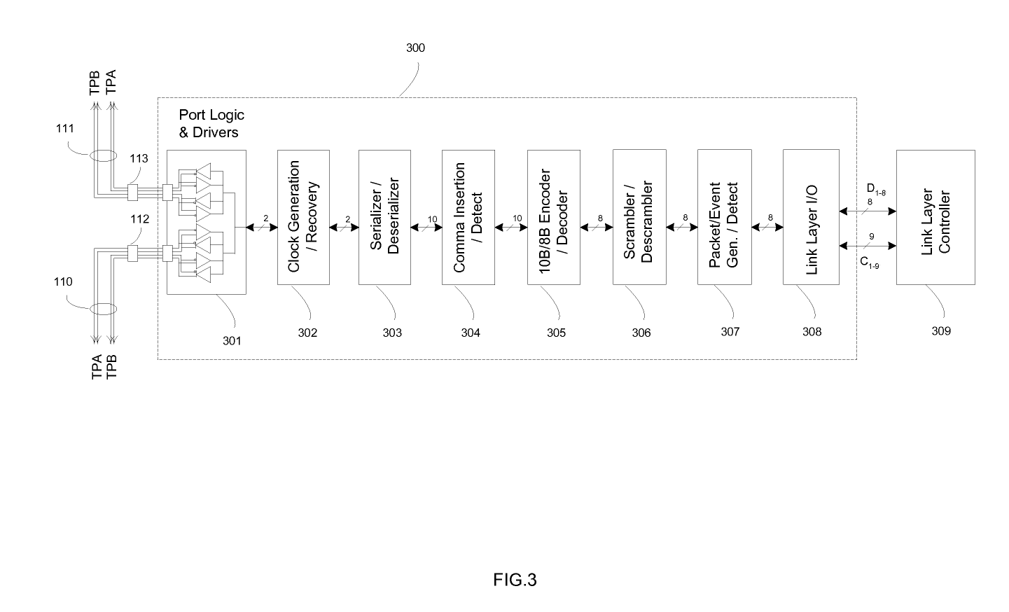

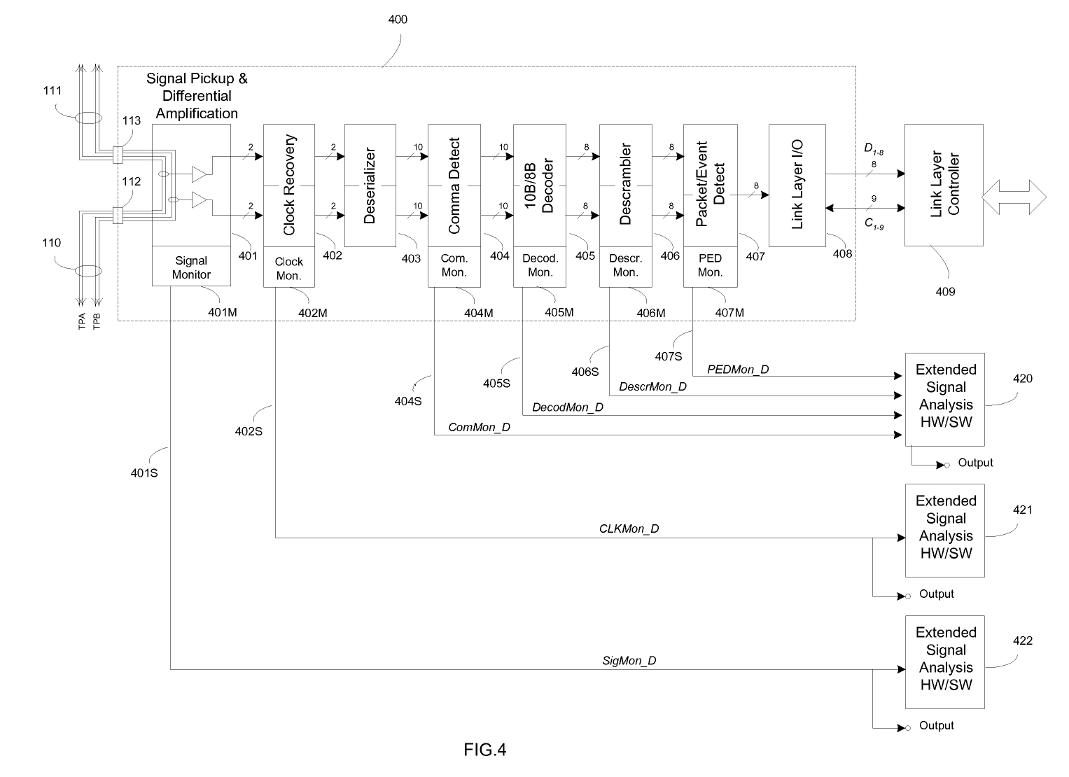

### BACKGROUND OF THE INVENTION

1. Field of the Invention

The present invention relates to a serial bus interface configuration to be connected to a digital interface typified by the IEEE1394b-2002 serial bus. More particularly, the invention relates to systems and methods for non-intrusive interface architectures that can be utilized in passive bus monitoring and analysis devices.

2. Background and Related Art

Since its invention in 1995 the high speed serial bus interface IEEE1394 has been adopted for a wide variety of applications. Originating initially in the consumer electronics market, IEEE1394 has found its way into many different market segments ranging from storage, to medical, automotive, aerospace and even military applications. Specifically the latest IEEE1394b-2002 revision (also called 1394b) has opened the door for a completely new generation of 1394 enabled devices. The higher data rate, the 8b10b encoding scheme, support for longer cable distances, etc. have made IEEE1394 a preferred data interface for new communication systems with deterministic requirements. Typical examples can be found in several aerospace applications where IEEE1394 is being used for aircraft flight control, military mission control commercial avionics and in-flight entertainment systems.

In certain environments (for example in the aerospace and defense (A&D) world) the number of devices connected to the IEEE1394 bus gets close to, or already has reached, the maximum (i.e. 64) of allowed devices. However, the nature of these implementations requires additional devices for activity monitoring purposes. And furthermore, deterministic bus architectures (e.g. the SAE Mil1394 standard) with very specific bus topologies inherently have difficulties with bus monitoring systems and/or devices. In these bus systems the concept of dynamically changing topologies has been widely removed to make 1394 suitable for mission critical and flight safety applications.

Data analyzers, protocol analyzers or data recorders are in general designed to record transmission data on communication interfaces. While data analyzers are typically used to capture the entire bus traffic and analyze proper device behavior for a specific communication technology, protocol analyzers have emerged as tools specifically for the higher level protocol layers. They are focusing on standardized communication methods or schemes which where developed to foster multi-vendor device interoperability and standardization. Data Recorders on the other hand often focus on very specific subsets of data exchange. In avionics applications they can be, but don't have to be, configured to monitor and log application-specific data patterns while ignoring the encapsulating packet structure or the protocol handshake in order to reduce the data set. From an implementation point-of-view the difference lies in an intelligent data management approach.

What all the devices mentioned above have in common is a requirement to access the data transmitted on the bus. This is typically accomplished by using a standard bus interface which, as in many different serial bus technologies, is usually referred to as physical layer silicon (PHY). In practice these chips are normally developed by big silicon manufacturers who are naturally tailoring the device functionalities towards the market segments with the highest sales volume expectations. The “data recording market” (including the devices mentioned above) is typically not generating enough volume in order to justify the cost of additional functionality or even a separate silicon development/spin. Therefore, manufacturers of data recording equipment are limited by the functionality provided in off-the-shelf silicon or are forced into expensive custom developments.

A serious shortcoming in off-the-shelf PHYs—from the data monitoring point-of view—is the “intrusive” nature of regular PHY silicon. Commercial PHYs are architectured to provide both receive (RX) and transmit (TX) functionality since regular bus devices want to receive as well as send data. Therefore it is a requirement that these devices fully participate in the tree identification, bus enumeration and become real participants on the bus. This, however, is not necessarily the case for pure “data monitoring” devices. If the goal is to provide only data monitoring (listening) functionality, it is actually desired that the “monitor” is not part of the bus as it influences and changes the system under test. The dynamic nodeID enumeration in IEEE1394 would stay unaffected when “connecting” a non-intrusive monitor (see Error! Reference source not found. and Error! Reference source not found.).

A typical example of this problem is shown in Error! Reference source not found. A number of IEEE1394b-2002 devices (101-104) are connected via 1394b connections (110) while the fault tolerant connection (111) is disabled via the automatic loop braking mechanism provided in IEEE1394b-2002. The addition of an additional device is shown in Error! Reference source not found. All devices' nodeIDs (101-104) get re-enumerated as a new tree-identification process reconfigures the bus. In this example the bus monitor ends up at the bottom of the tree with the lowest nodeID. When added to the bus via a different connection location there is fair chance that the newly added device 212 wins the arbitration and becomes the root node (device with the highest node ID). Only in this case all other nodeIDs stay the same. However, it must be pointed out that for most testing applications this is a highly undesirable configuration. In IEEE1394 the root node has a very specific status with some important bus supervision functions. Having the monitor be the root and having him take over these responsibilities is a severe change of the system under test and bears very little resemblance to the original configuration.

Another issue is the input/output buffer delay when using regular PHY silicon. PHYs work as signal reconditioners and retransmitters. Signals or data received on one port are actually reconditioned and retransmitted with a delay on all other connected ports. From a pure data analysis/network optimization point-of-view, this is an undesired feature for an “analyzer” and should be avoided.

In the past, “no-node” bus interfaces and analyzers have been developed for IEEE1394a-2000 systems. One method of “spying” on the twisted pair signal lines is having a MUX switch the effective data path for a high impedance pickup logic. This approach does not work in IEEE1394b-2002 due to its different signaling mechanism. Another method works on the basis of suppressing the transmission of SelfID packets by the PHY layer chip and transmitting an indent_done signal from a child node directly to a parent node. While simple, this concept causes detailed problems as the device is actually part of the bus; it just fools the others by making itself “invisible”.

### SUMMARY OF THE INVENTION

It is an objective of this invention to provide an apparatus, which can be connected to the IEEE1394b-2002 bus without the apparatus being recognized by the network. The apparatus allows recording of all bus activity without interfering with the bus system at all.

Additionally, optimized monitoring functions provide important information on signal quality, bus clock, etc. and give a much better overall understanding about IEEE1394b-2002 bus signaling and additional troubleshooting capabilities than regular bus analyzing devices utilizing commercial off-the-shelf PHY silicon.

### BRIEF DESCRIPTION OF THE DRAWINGS

In order to describe the manner in which the above-recited and other advantages and features of the invention can be obtained, a more specific description of the invention briefly described above will be rendered by reference to specific embodiments thereof which will be illustrated in the appended drawings. Understanding that these drawings depict only typical embodiments of the invention and are not therefore to be considered to be limiting in its scope, the invention will be described and explained with additional specificity and detail through the use of the accompanying drawings in which:

Error! Reference source not found. illustrates a block diagram of IEEE1394b-2002 bus configuration with a fault tolerant bus connection.

Error! Reference source not found. illustrates two possible IEEE1394b-2002 bus topologies resulting from the addition of a bus monitoring device.

Error! Reference source not found. illustrates functional blocks typically found in a regular physical layer device.

Error! Reference source not found. illustrates the functional blocks of this invention.

### DETAILED DESCRIPTION OF THE PREFERRED EMBODIMENTS

In order to fully understand the non-intrusive IEEE1394b-2002 serial bus interface as a preferred embodiment of this invention it is necessary to review the main function blocks of a typical IEEE1394b-2002 physical layer device (PHY). Error! Reference source not found. shows a block diagram of the data flow for a standard PHY device (300) with its main functional blocks, i.e. Port Logic & Drivers (301), Clock Generation/Recovery (302), Serializer/Deserializer (303), Comma Insertion/Detect (304), 8b/10b Encoder/Decoder (305), Scrambler/Descrambler (306), Packet/Event Generation/Detect (307) and Link Layer I/O (308). Detailed descriptions of these functional blocks can be found in the IEEE1394b-2002 specification. Such a physical layer device would be mounted on a printed circuit board and connected on one side to different 1394 bus branches via one or multiple connectors. Error! Reference source not found. shows a configuration with two connectors 112 and 113 connected to the two bus branches 110 and 111. The other side of the PHY (400) is then connected to a Link Layer Controller device (LLC) 109 that by itself is connected to the host bus. This completes a 1394 interface capable of 1394b receive and transmit functions.

The present invention provides an interface to “connect” to the bus in a non-intrusive way. In the preferred embodiment of this invention is shown in Error! Reference source not found. The typical port I/O logic together with its I/O buffers is replaced with high-impedance data pick-up systems and subsequent line amplifications (401). An adequate impedance matched design is critical to provide the required “isolation” from the twisted pair lines. Although not explicitly shown in Error! Reference source not found., an alternative embodiment of this invention provides an interface to an optical physical medium. Both plastic as well as glass optical fibers are specified transfer media for IEEE1394b-2002. While conceptually identical, the high impedance data pickups in this case are replaced with a low-attenuation signal splitter and an appropriate optical/analog converter. In the preferred embodiment of this invention this front stage section also incorporates a Signal Quality Monitoring function (401M). Analyzing the analog signal tokens not only provides access to the digital data content but also to signal quality characteristics like signal strength, jitter and others. In this embodiment of the invention the resulting signals (401S) are fed into an integrated high-level analysis module 422 (hardware, firmware and/or software) and/or to external signal evaluation tools (e.g. oscilloscope with eye pattern analysis capability . . . ).

The signal outputs of block 401 are subsequently used as inputs for the Clock Recovery block 402. It separates the so far combined clock and data/control/arbitration symbols. As the preferred embodiment of this invention provides receive capabilities only, block 402 does not include a clock encoding mechanism. However, the preferred embodiment of this invention adds a Clock Monitor function (402M). The resulting recovered clock output signal (402S) is fed into an integrated high-level analysis module 421 (hardware, firmware and/or software) and/or to external clock frequency evaluation tools (e.g. oscilloscope with jitter analysis capability . . . ).

The signal output of block 402 is used as an input for the Deserializer block 403 which converts the so far serial bit stream into a parallel bus interface. Its 10-bit wide output is then routed into the Comma Detect block 404. In the preferred embodiment of this invention the Comma Detect block 404 provides the 10-bit incoming input signal stream together with a number of, derived from Comma Detect Monitor 404M, information signals 404S relevant to Comma Insertion/Detection, for performing the enhanced analysis foreseen as an option to an integrated high-level analysis module 420 (hardware, firmware and/or software) and/or to an appropriate external analysis tool.

The subsequent 8b/10b decoder (405) converts the DC balanced 10-bit interface into an 8-bit version. In the preferred embodiment of this invention the Decoder 405 provides the 8-bit decoded symbols together with a number of, derived from Decoder Monitor 405M, information signals 405S relevant to the 8b/10b en/decoding, for performing the enhanced analysis foreseen as an option to an integrated high-level analysis module 420 (hardware, firmware and/or software) and/or to an appropriate external analysis tool.

The 8-bit wide signal output from block 405 is used as an input into the Descrambler 406. 1394b data, control and request symbols are scrambled in order to avoid the generation of repetitive sequences of identical 10-bit characters. Such sequences could concentrate energy at discrete frequencies and henceforth cause electromagnetic issues. In the preferred embodiment of this invention the Descrambler 406 provides the 8-bit descrambled symbols together with a number of, derived from the Descrambler Monitor 406M, information signals 406S relevant to scrambling/descrambling, for performing the enhanced analysis foreseen as an option to an integrated high-level analysis module 420 (hardware, firmware and/or software) and/or to an appropriate external analysis tool.

The Packet/Event builder (407) separates data, control and requests. In the preferred embodiment of this invention the Packet/Event builder (407) provides the 8-bit incoming symbols together with a number of, derived from PEB Monitor 407M, information signals 407S relevant to packet and event building, for performing the enhanced analysis foreseen as an option to an integrated high-level analysis module 420 (hardware, firmware and/or software) and/or to an appropriate external analysis tool. The regular signal output for the Packet/Event builder (407) connects to the LLC I/O (408) which provides the direct interface to the Link Layer controller (LLC) 409.

In the preferred embodiment of this invention the monitoring signals 401S-407S are connected directly to integrated high-level analysis modules 420-422 (hardware, firmware and/or software) and/or to appropriate external analysis tool. It should be pointed out that other methods of feeding these signals into the analysis modules are acceptable and are included in this application. For example, the signals 401S-407S could be multiplexed in an appropriate multiplexing device. Such an approach reduces the amount of data. However, careful consideration must be given to sampling frequency, etc. The mentioned high-level analysis modules 420-422 allow extended analysis functionality that go beyond the scope of this application.

What is claimed is:

1. A physical layer bus interface for use in an IEEE1394b-2002 bus activity monitoring device, the interface having the functionality of a completely non-intrusive bus monitoring device as well as monitoring functions for the different functional blocks of a 1394b interface.

2. A physical layer bus interface according to claim 1, further comprising of an electrical media interface allowing to connect two commercial 1394b bus cables to the invention.

3. A physical layer bus interface according to claim 1, alternatively comprising of an optical media interface allowing to tap into the optical transmission lines of a fiber optic connection.

4. A media interface according to claim 2, further comprising two 1394b connectors and circuit board traces connecting the connectors in such a way that the combination of two cables and the circuit board traces meet continuity requirements of one single 1394b cable.

5. A media interface according to claim 2, wherein the two 1394b connectors and the circuit board traces together with the 2 cables meet standard 1394b impedance criteria.

6. A Data Pickup and Differential Amplification function according to claim 1, comprising of a set of high impedance data probing hookups connected directly to one or both differential signal pairs and a pair of differential amplifiers.

7. A set of high impedance hookups according to claim 6, wherein the probes are designed to have a minimal or neglectable effect (within the specified parameters of IEEE1394b-2002) on the signal quality of bus signals.

8. A set of high impedance hookups according to claim 6, wherein the probes have a minimal or neglectable effect (within the specified parameters of IEEE1394b-2002) on signal transmission latencies.

9. A physical layer bus interface according to claim 1, wherein the interface has a minimal or neglectable effect (within the specified parameters of IEEE1394b-2002) on the bus arbitration.

10. A physical layer bus interface according to claim 9, wherein the interface has a minimal or neglectable effect (within the specified parameters of IEEE1394b-2002) on the tree identification and bus enumeration.

11. An individual Monitor or set of Monitors according to claim 1, wherein the usual functional blocks in a commercial 1394b interface device are complemented with dedicated analysis and monitoring functions.

12. A Signal Quality Monitor according to claim 11, wherein the monitor generates output signals containing information about the functional behavior of the Signal Pickup and Amplification block.

13. A Clock Recovery Monitoring according to claim 11, wherein the monitor generates output signals containing information about the functional behavior of the Clock Recovery block.

14. A Comma Detect Monitor according to claim 11, wherein the monitor generates output signals containing information about the functional behavior of the Comma Detect block.

15. An 8b/10b Decoder Monitor according to claim 11, wherein the monitor generates output signals containing information about the functional behavior of the 8b/10b Decoder block.

16. A Descrambler Monitor according to claim 11, wherein the monitor generates output signals containing information about the functional behavior of the Descrambler block.

17. A Packet and Event Builder Monitor according to claim 11, wherein the monitor generates output signals containing information about the functional behavior of the Packet and Event Builder block.
